(19) United States
(12) Patent Application Publication
(10) Pub. No.: US 2009/0030901 A1
(43) Pub. Date: Jan. 29, 2009

(54) SYSTEMS AND METHODS FOR FAX BASED DIRECTED COMMUNICATIONS

(75) Inventor: Nils Graef, San Jose, CA (US)

Correspondence Address: Hamilton,DeSanctis & Cha (LSI), 8601 W. CROSS DRIVE, F5-301, LITTLETON, CO, 80123, US

(73) Assignee: Agere Systems Inc.

(21) Appl. No.: 11/781,364

(22) Filed: Jul. 23, 2007

(51) Int. Cl. G06F 17/30

(52) U.S. Cl. 707/6; 707/3

(57) ABSTRACT

Various embodiments of the present invention provide systems and methods for responding to business related queries. As one example, such methods may include providing a communication direction associated with a particular business, and receiving a query via the communication direction. The received query is directed to a third party support service where it is parsed and one or more elements of the query are compared against a prior query. A response to the query was previously supplied by the particular business. A response is provided to the query that includes at least a portion of the reply to the prior query.

### BACKGROUND OF THE INVENTION

The present invention is related to systems and methods for communicating, and more particularly to systems and methods for providing information to and receiving information from a business.

Traditionally, communications with a business have been done using a telephone. The ubiquity of telephones in businesses along with the pervasiveness of telephone directories used for advertising purposes have enforced the continued use of telephones as a preferred mode of communication for business establishments. As businesses maintain fax machines and advertise fax numbers almost to the extent of telephone numbers, the use of fax machines have also been culturally instilled as a preferred communication approach for general communications with businesses. The advent of the Internet and email certainly has changed some aspects of the way business operates, but surprisingly the impact on general communications with a business has been limited as many businesses still rely on telephone and fax service as primary means for communicating with their customers. In a typical scenario, one or more employees of the business may have email addresses, but a general email address for the overall business either does not exist or is not consistently monitored or is not monitored in a timely fashion. For this reason, many potential customers prefer to employ telephone contact when soliciting information from a business. This reality is often reflected in websites maintained by many retail businesses where telephone contact is encouraged.

While telephone contact seems to continue as the norm for contacting a retail establishment, in many instances such contact is not the most effective. For example, telephone contact tends to interrupt ongoing processes, and thus may not be as convenient as using more modern communication methods. Further, providing complex information over the telephone is often a very frustrating experience. Even with these limitations, the use of telephone contact with a retail business remains the most common method for providing information to and receiving information about a particular business.

Hence, for at least the aforementioned reasons, there exists a need in the art for advanced systems and methods for communications with businesses.

### BRIEF SUMMARY OF THE INVENTION

The present invention is related to systems and methods for communicating, and more particularly to systems and methods for providing information to and receiving information from a business.

Various embodiments of the present invention provide methods for responding to business related queries. Such methods include providing a communication direction associated with a particular business, and receiving a query via the communication direction. The received query is directed to a third party support service where it is parsed and one or more elements of the query are compared against a prior query. A response to the prior query would typically have been provided by the particular business. A response is provided to the received query that includes at least a portion of the reply to the prior query. In some instances of the aforementioned embodiments, the communication direction is a fax number associated with the particular business, and the query is received as a fax. In various instances of the aforementioned embodiments, the methods further include receiving a request to identify a class of businesses that includes the particular business, and graphically displaying two or more businesses included in the class of businesses in relation to a map.

In particular instances of the aforementioned embodiments, the particular business is a first business, the communication direction is a first communication direction, the class of businesses includes a second business, and the prior query is a first prior query. In such instances, the method may further comprise: receiving the query via a second communication direction that is associated with the second business; comparing the one or more elements of the query against a second prior query. A reply to the second prior query was previously supplied by the second business. The method further includes providing a response originally received from the second business in relation to the query. In some instances, at least a portion of the query is automatically populated from a database or profile. In a particular instance, the automatically populated portion of the query includes information selected from a group consisting of: an address of a requester, the name of a requestor, and contact information associated with a requester.

Other embodiments of the present invention provide methods for communicating information in relation to a telephone/fax covered business. Such methods include receiving a selection of two or more businesses via a portal. The two or more businesses may be of the same business type. A query germane to the business type is received, and at least a portion of the query is faxed to each of the two or more businesses. In some instances of the aforementioned embodiments, the methods further include providing a first fax number associated with a first business included in the two or more businesses, and a second fax number associated with a second business included in the two or more businesses. Such instances further include receiving the query via the first fax number and the second fax number. The query is directed to a third party support service where it is parsed to identify one or more elements thereof, and to compare the one or more elements with a first prior query that was previously replied to by the first business, and with a second prior query that was previously responded to by the second business. A first response to the query is provided that includes at least a portion of the reply to the first prior query, and a second response to the query is provided that includes at least a portion of the reply to the second prior query.

Yet other embodiments of the present invention provide systems for responding to business related queries. Such systems include a computer and a computer readable medium. The computer readable medium includes instructions executable by the computer to provide a fax number associated with a particular business, and to receive a query from the user via the Internet web site. The received query is directed to a third party support service where it is parsed and compared against a prior query that was previously responded to by the particular business. The instructions are further executable to provide a response to the query. The response includes at least a portion of the reply to the prior query.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIGS. 1a-1b represent graphical displays of a number of subscribing businesses in relation to a map;

FIG. 2 depict a business class or type selector that may be employed in relation to one or more embodiments of the present invention;

FIG. 3 shows a system for business communications in accordance with various embodiments of the present invention;

FIG. 4 is a flow diagram depicting a method in accordance with some embodiments of the present invention; and

FIG. 5 is a flow diagram depicting another method in accordance with various embodiments of the present invention.

### DETAILED DESCRIPTION OF THE INVENTION

The present invention is related to systems and methods for communicating, and more particularly to systems and methods for providing information to and receiving information from a business.

Various embodiments of the present invention provide systems and methods for responding to business related queries. As an example, one method in accordance with embodiments of the present invention includes providing a communication direction associated with a particular business, and receiving a query via the communication direction. As used herein, the phrase “communication direction” is used in its broadest sense to mean any indication of a destination of a communication. Thus, for example, a communication direction may be, but is not limited to, a fax number associated with a business to which the communication is directed or an email address associated with the business to which the communication is directed. The received query is directed to a third party support service where it is parsed and one or more elements of the query are compared against a prior query. Such parsing may be directed toward reducing the query to constituent elements, thus, allowing the query to be compared with previously received queries to determine potential matches. Such parsing may further be directed toward separating two or more queries included in a single communication. A response to a prior query would typically have been provided by the particular business, and maintained in a database or profile associated with the particular business. A response is provided to the received query that includes at least a portion of the reply to the prior query.

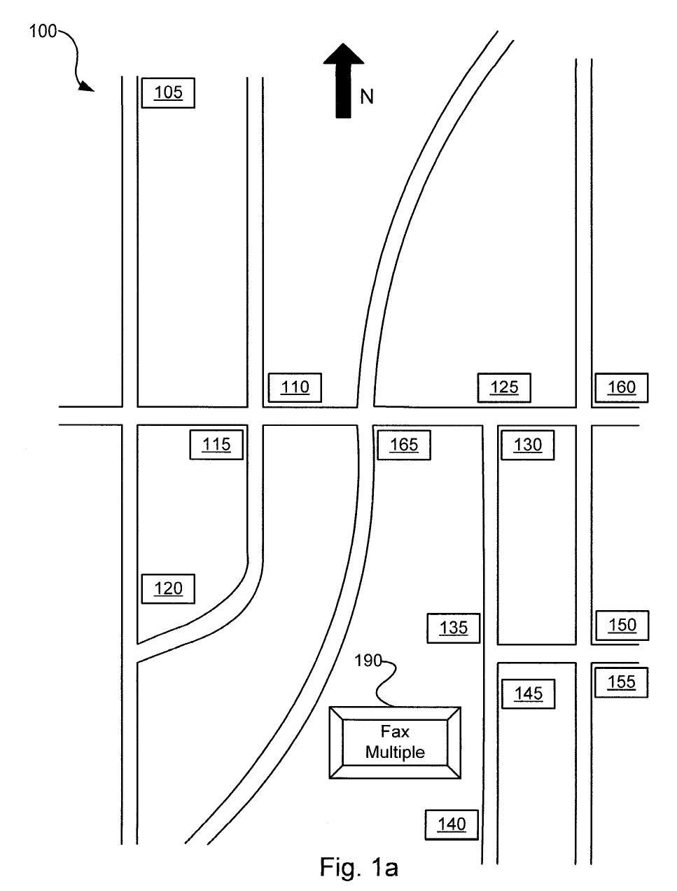

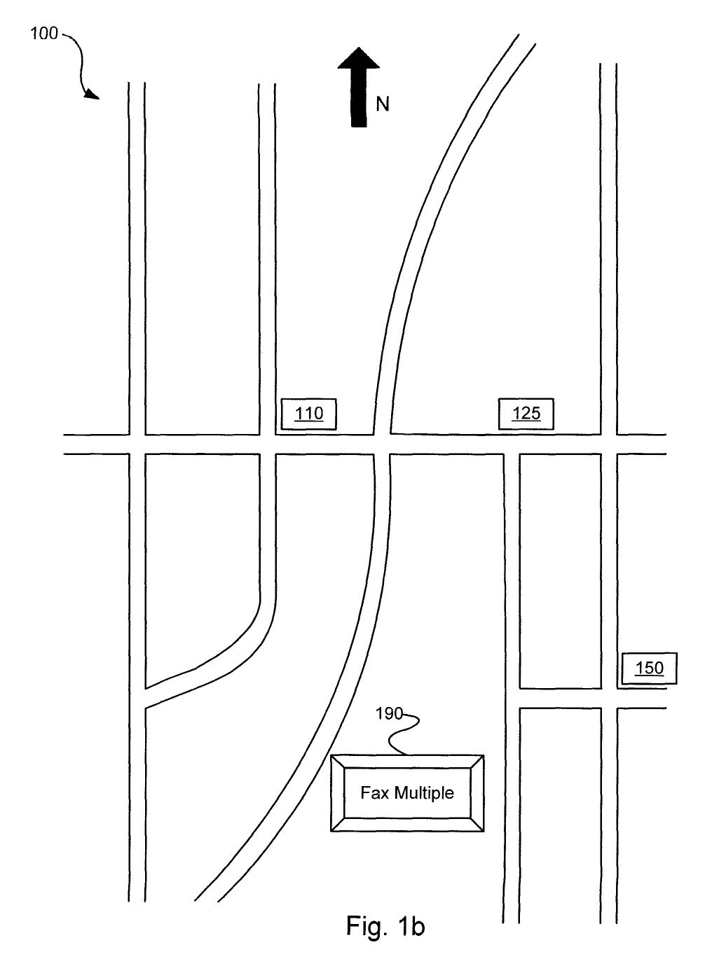

Turning to FIG. 1a, an electronically displayed map 100 shows a number of businesses 105, 110, 115, 120, 125, 130, 135, 140, 145, 150, 155, 160, 165 in relation to a variety of roads or other landmarks. Unlike other maps, each of businesses 105, 110, 115, 120, 125, 130, 135, 140, 145, 150, 155, 160, 165 subscribe to a fax based communication service in accordance with one or more embodiments of the present invention. It should be noted that in various embodiments of the present invention the businesses do not subscribe to any service, but are rather only identified with the service. Thus, for example, where map 100 is interactively displayed to a user via a display, the user may be able to click on one or more of the businesses and to submit a query to the selected business. The query may be formed into a business friendly fax format that is supported by the selected business, and that does not necessarily require a business owner to interrupt their normal processes to answer the query in contrast to a query initiated via a telephone.

In some embodiments of the present invention, a fax communication from a user may be initiated to the businesses displayed on map 100. To do so, a user would click a fax multiple button 190 that is displayed in relation to map 100. Selecting the button would cause a user interface to appear allowing a user to enter one or more queries that are to be directed to the depicted businesses. In this case, the entered query would be sent via fax to each of businesses 105, 110, 115, 120, 125, 130, 135, 140, 145, 150, 155, 160, 165. It should be noted that any number of businesses may be depicted, and that FIG. 1a shows an example of businesses that may be depicted.

In some embodiments of the present invention, map 100 is updated through access to a website supporting maps. In one particular case, a user enters a command such as, for example, “Show All Subscribing Businesses within a [Distance] from [Address]”. As another example, a user may enter a command such as, for example, “Show All Subscribing Businesses Bounded by [STREETS]”. Such commands cause all subscribing businesses within the boundaries defined by the identified businesses to be depicted in relation to the map. When either of these commands is received, all businesses within the particular region are identified and the appropriate map is displayed to the user. Of note, these businesses may subscribe to a communication service in accordance with one or more embodiments of the present invention. Thus, the identified businesses may not represent all businesses in the particular area, but rather only subscribing businesses. Again, it should be noted that businesses need not be “subscribing” businesses, but rather may be just businesses that are identified by the service. In some cases, a combination of subscribing and non-subscribing businesses may be accessible in accordance with other embodiments of the present invention.

In some cases, the businesses may be sorted by business type. When such is done, only a subset of the previously identified businesses are displayed in relation to the map. Turning to FIG. 1b, a map 101 showing only a subset of the businesses is depicted. As shown, only businesses 110, 125 and 150 remain. In such a case, clicking on fax multiple button 190 causes a user interface to appear allowing a user to enter one or more queries that are to be directed to the depicted businesses. In this case, the entered query would be sent via fax to each of businesses 110, 125, 150.

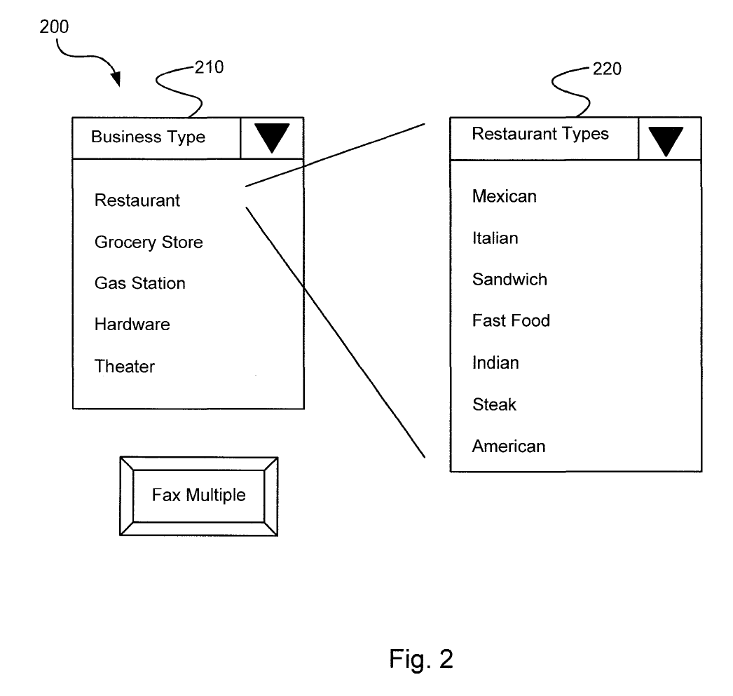

Such a reduction in the displayed business may be accomplished using a business class or type selector 200 shown in FIG. 2. As shown, business class or type selector 200 provides a pull down menu 210 that allows a user to select from a number of predefined business types that may include, for example, Restaurants, Grocery Stores, Gas Stations, Hardware Stores and Theaters. One or more of the business types may include a sub-category. For example, a pull down menu 220 shows a sub-category for restaurants. The sub-category allows a user to further reduce the number of restaurants that would be displayed based on the type of food served. As an example, pull down menu 220 allows a user to further limit the selected restaurant category to Mexican, Italian, Sandwiches, Fast Food, Indian, Steak and American food. Based on the disclosure provided herein, one of ordinary skill in the art will recognize a variety of business classes or types that may be offered to a user for selection, and a number of different sub-categories in relation to one or more of the business types that may be provided to a user. Further, one of ordinary skill in the art may recognize a variety of other user interface types that may be implemented in accordance with one or more embodiments of the present invention to allow a user to select a region or location, a class of businesses, and any business subclasses.

In other embodiments of the present invention, particular businesses designated to receive a fax communication may be identified through, for example, a search function. As a particular example, a user may input a search query of “Pizza” within zipcode “12345”. A number of restaurants offering pizza may then be produced for the user, and the user may select to send a fax to each of the identified businesses. Based on the disclosure provided herein, one of ordinary skill in the art will recognize other approaches for identifying businesses in accordance with different embodiments of the present invention.

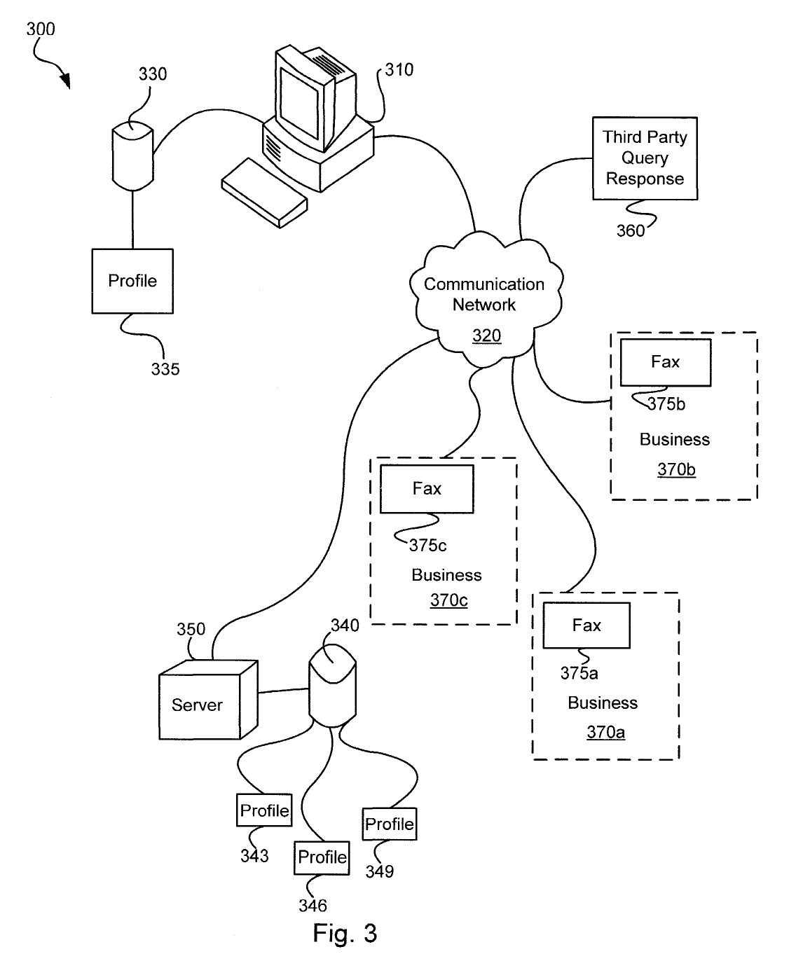

Turning to FIG. 3, a directed communication system 300 in accordance with one or more embodiments of the present invention is depicted. Directed communication system 300 includes a user computer 310 that is capable of accessing a computer readable medium 330 having thereon a profile 335. In some instances, computer 310 is a personal computer as is known in the art. As used herein, the phrase “computer readable medium” is used in its broadest sense to mean any storage device, element and/or system that a computer is capable of reading data from and writing data to. Thus, for example, a computer readable medium may be a hard disk drive, a floppy disk drive, a CD ROM, a magnetic tape, a floppy disk drive, combinations of the aforementioned, and/or the like. Computer readable medium 330 may be integrated with user computer 310, or may be only communicably coupled to user computer 310. Profile 335 includes various information about the user such as, but not limited to, the user's name and contact information.

Directed communication system 300 further includes at least one or more businesses 370 that utilize a standard fax machine 375 or at least includes some ability to receive a fax. It should be noted that while three businesses are shown, that any number of businesses may be incorporated into directed communication system 300. Directed communication system 300 further includes a server 350 that is communicably coupled to a computer readable medium 340. Computer readable medium 340 may be integrated with server 350, or may be only communicably coupled to server 350. Computer readable medium 340 includes a number of profiles 343, 346, 349. Each of profiles 343, 346, 349 is associated with respective subscribing businesses. Thus, for example, profile 343 may be associated with business 370a, profile 346 may be associated with business 370b, and profile 349 may be associated with business 370c. A profile associated with a subscribing business may include the following information, but is not necessarily limited to the following information: the business name, contact information, driving directions, special offers, advertisements, combinations of the aforementioned, and/or the like. Further, a profile includes an evolving database of frequently asked questions and associated answers that have been posed to an associated businesses and responded to by the associated businesses. Thus, where a question is posed to a business associated with the profile, the answer to the question may be incorporated into the profile where the question has not been previously answered. In this way, server 350 has an evolving ability to respond to queries for a particular business. As no two businesses will respond to all queries in the same way, the frequently answered question database in one profile associated with one business will be distinct from the frequently answered question database in another profile associated with another business.

Computer readable medium 340 further includes software instructions that when executed by server 350 cause one or more web pages to be available via user computer 310 upon request from user computer 310. Such web pages may provide an ability for a user via user computer 310 to select a region of interest, and to display subscribing businesses within the region of interest. Further, the web pages may provide an ability to select the type or class of subscribing businesses within the region of interest. Thus, the provided web pages may provide the abilities and user interfaces discussed in relation to FIG. 1 and FIG. 2 above. It should be noted that the user interfaces discussed above in relation to FIG. 1 and FIG. 2 above are merely exemplary, and that one of ordinary skill in the art will recognize a number of user interfaces that may be provided via web pages to allow a user to operate and/or interact with directed communication system 300 in accordance with one or more embodiments of the present invention.

Directed communication system 300 further includes a third party query response entity 360. Third party query response entity 360 may be designated by one or more of businesses 370 to receive queries directed to the particular business 370, and to respond to those faxes on behalf of the business. In one particular embodiment of the present invention, third party query response entity 360 includes a fax machine or equipment capable of receiving information originally transmitted by user computer 310 as a fax communication. Each of user computer 310, server 350, fax 375 and third party query response entity 360 are communicably coupled one to another via a communication network 320. Communication network 320 may be any type of communication network capable of transmitting electronic messages between two or more entities. Thus, communication network 320 may be, but is not limited to, the Internet, a virtual private network, a wide area network, a telephone network, combinations of the aforementioned, and/or the like. Based on the disclosure provided herein, one of ordinary skill in the art will recognize a variety of communication network that may be used in relation to various embodiments of the present invention.

In operation, a user accesses user computer 310 to access one or more web pages supported by server 350. The user selects a region of interest and a class or type of business of interest. In response, server 350 serves a web page depicting the selected class of businesses in relation to a map covering the selected region of interest. A user may then use user computer 310 to initiate a fax communication to one or more of the depicted businesses by entering the query in a text field provided by the interactive website. The user may include a query that will be provided to each of the depicted businesses, and may include information such as, for example, the user's name and contact information that is obtained from profile 335.

In turn, a fax is directed to each of the depicted businesses using fax numbers associated with each of the respective businesses. Rather than immediately directing the faxes to the individual businesses, the faxes are redirected to server 350. Server 350 parses the query included in the faxes and compares the query with frequently asked questions lists that are maintained in profiles 343, 346, 349. In particular, business 370 may be associated with profile 343, and the frequently asked question list in profile 343 would have been populated based on information specific to business 370. Where the user's query matches that in the frequently asked questions list, the response from the frequently asked questions list is provided back to the user as if the business identified by the user had responded directly to the user's original query issued to the fax of the business. This response may be provided back to the user as a fax, an email, a cell phone text message, or by posting to the web page where the user is viewing the business in relation to a map, or some other way.

Alternatively, where the user's query is not included in the frequently asked questions list for the particular business, the query may be forwarded to third party query response entity 360 that may be contracted by business 370 to respond to incoming questions. Where such is the case, third party response entity 360 formulates a response to the query and forwards the response to server 350. Upon receiving the response, server 350 updates the frequently asked questions list associated with the particular business to which the query was directed. Thus, the frequently asked questions list evolves over time leaving fewer and fewer questions that remain unanswered by the particular business. In some cases, it may be advantageous for a business to review and edit the frequently asked questions list to assure accuracy. Such a review may be particularly warranted where a substantial policy change or direction has occurred at the business that may render previous responses inaccurate. Server 350 then sends the response to the user as if it originated from the particular business.

As yet another alternative, the user's query that was not covered by the frequently answered questions list may be forwarded directly to the identified business. In such a case, the business formulates a response to the query and provides the formulated response to server 350. Upon receiving the response, server 350 updates the frequently asked questions list associated with the particular business to which the query was directed. Again, this allows the frequently asked questions list to evolve over time leaving fewer and fewer questions that remain unanswered by the particular business. Server 350 then sends the response to the user as if it originated from the particular business.

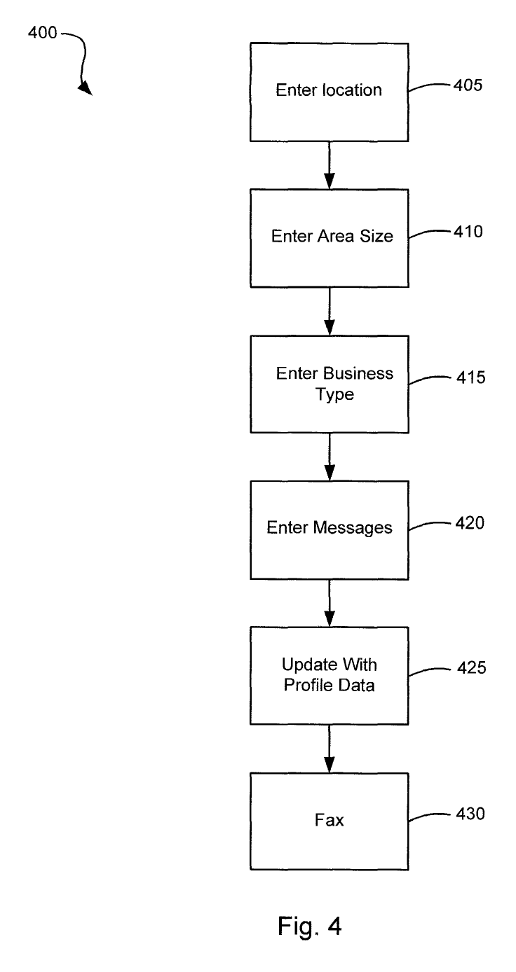

Turning to FIG. 4, a flow diagram 400 shows a method in accordance with one or more embodiments of the present invention for initiating a query via a broadcast fax in accordance with various embodiments of the present invention. Following flow diagram 400, a location of interest is entered (block 405) and an area size is entered (block 410). This may be done, for example, via a web page where the user indicates a central location and a region extending around the central location. As an alternative, this may be done via, for example, a web page where the user indicates boundaries defining a region of interest. Based on the disclosure provided herein, one of ordinary skill in the art will recognize a variety of approaches that may be used in accordance with one or more embodiments of the present invention for identifying a region of interest.

In addition, a user may enter a business type of interest (block 415). In some cases, the user may not enter anything in which case all businesses are shown. Alternatively, where the user provides an indication of business type, the businesses that are not of the selected type are no longer considered or depicted. Based on the disclosure provided herein, one of ordinary skill in the art will recognize a myriad of business types that may be selected, and various approaches for soliciting such business type information including sub-types from a user. Each of the identified businesses includes a respective fax number to which a potential customer may direct comments or queries. Thus, for example, where three businesses are selected, three distinct fax numbers may be supported—one for each of the three distinct businesses. Alternatively, one or more of the businesses may share a common fax number.

A user then enters a query that is to be directed to each of the identified business types (block 420). Such a query may be entered via any editor known in the art. The query is then augmented with information obtained from a profile associated with the user (block 425). This information may include, for example, the user's name and contact information. Based on the disclosure provided herein, one of ordinary skill in the art will recognize a variety of profile data about a user that may be maintained, and a variety of approaches for using profile data to augment a directed query. In some embodiments of the present invention, the information is automatically populated into the query only after a virtual button is clicked by the user. Once the query is thus prepared, it is communicated to the identified businesses as a fax communication (block 430). This may include providing a number of fax transmissions each directed to one of the identified businesses.

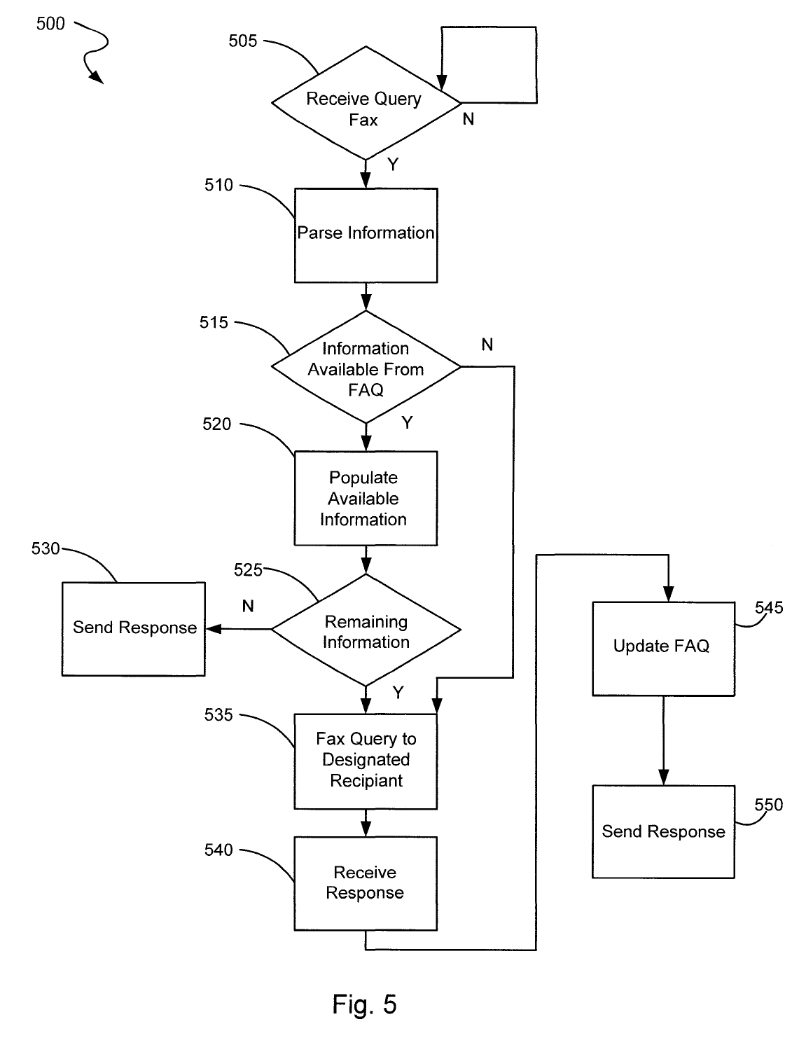

Turning to FIG. 5, a flow diagram 500 shows a method in accordance with one or more embodiments of the present invention for receiving a fax query directed to a particular business in accordance with one or more embodiments of the present invention. Following flow diagram 500, a fax query is received (block 505). This fax query may be received by a support service subscribed to by the business to which the fax query is directed (i.e., the business associated with the fax number used to direct the fax query). The receiving support service operates server 350 that receives the fax query and parses the information contained in the query (block 510). It should be noted that where the query is sent out to a number of businesses via fax numbers associated with the respective businesses that server 350 may receive the same query directed to two or more businesses that it supports. In such cases, server 350 may perform only a single parse of the information, or may perform a parse for each query received. It should also be noted that where the same query is sent to multiple businesses, that server 350 may only receive one of the queries as other of the queries may be directed to other servers maintained by a support service subscribing two or more of the businesses, or to other support services.

Once the information in the query is parsed (block 510), it is determined if a response to the query is available from a frequently answered questions list maintained in relation to the business to which the query is directed (block 515). Where the query is not adequately matched up to a previously submitted query represented in the frequently asked questions list (block 515), the query is forwarded to a fax machine maintained by the identified business (block 535). In turn, the business formulates a response to the query, with the response being provided to the support service (block 540). The support service uses the query and associated response to update the frequently asked questions list (block 545). In this way, when a similar query is received, it need not be referred to the subscribing business, but may be answered by the support service. In addition, the response received from the business (block 540) is sent to the original requestor using the contact information provided by the requestor or to the fax number from which the original query was sent (block 550). In one particular embodiment of the present invention, the response is provided to the requester via email, alternatively, the response may be posted to the web page where the user is viewing the business in relation to the map. Based on the disclosure provided herein, one of ordinary skill in the art will recognize a myriad of approaches for responding to the requester that may be used in relation to the various embodiments of the present invention.

Alternatively, where the a response to one or more of the queries is included in the frequently asked questions list (block 515), the previous response to the query is accessed from the frequently asked questions list and is used in part to formulate a response to the original requester (block 520). It is then determined whether another query is included that is not adequately supported by the frequently asked questions list (block 525). Where no other query remains (block 525), the response from the frequently asked questions list is forwarded to the requester as if the business had responded to the request (block 530). Alternatively, where other queries are included that are not adequately addressed by the frequently asked questions list (block 525), the other queries are forwarded to the fax of the business with a request for a response (block 535). Similar to that described above, a response is received from the business (block 540), the frequently asked questions list is updated (block 545), and a response is sent to the requester as if the business had responded directly.

Based on the disclosure provided herein, one of ordinary skill in the art will recognize a variety of advantages associated with one or more embodiments of the present invention. For example, it is often inefficient and/or inconvenient to communicate with a business via telephone even though that may be the preferred method of communication with the business. Communication via telephone is particularly inconvenient where a requester is placed on hold while the business services other more immediate concerns. Indeed, it may be that the requestor merely wants to know the hours of business operation, available menu, or availability and cost of a certain product. Such information is easily obtained via the telephone, however, due to the interruption represented by a telephone call, the simple process can become very frustrating. This frustration can be exacerbated where the requestor is required to perform the tedious and often error prone action of spelling their name verbally over the telephone. Such tedious and error prone approaches may be reduced through use of one or more embodiments of the present invention. Further, shopping multiple businesses may require a phone call to each business where essentially the same questions are posed to each of the businesses. Such an approach is inefficient and tedious. One or more embodiments of the present invention provide a business friendly approach that reduces the current inefficient and tedious approach. One or more embodiments of the present invention offers benefits for the end user, for the subscribing business, and for the service provider. For example, a business may be provided with a more efficient means for communicating with customers and a service provider may be better able to target advertising through its access to incoming queries. Based on the disclosure provided herein, one of ordinary skill in the art will recognize a variety of other advantages that may be had through use of one or more embodiments of the present invention.

In conclusion, the invention provides novel systems, devices, methods and arrangements for fax based directed communications. While detailed descriptions of one or more embodiments of the invention have been given above, various alternatives, modifications, and equivalents will be apparent to those skilled in the art without varying from the spirit of the invention. For example, fax communications initiated in relation to embodiments of the present invention are not limited to queries only. Rather, such fax communications may be mass mailings or purchase orders. Further, fax communications are not limited to subscribing businesses. Rather, an interface may be provided that includes non-subscribing businesses or a combination of subscribing and non-subscribing businesses. Thus, where subscribing businesses are described herein, it should be recognized that it is merely exemplary and that such subscribing businesses may be replaced by non-subscribing or businesses that are otherwise not affiliated with the fax service. Therefore, the above description should not be taken as limiting the scope of the invention, which is defined by the appended claims.

What is claimed is:

1. A method for responding to business related queries, the method comprising:
providing a communication direction associated with a particular business;
receiving a query via the communication direction;
directing the query to a third party support service;
parsing the query, wherein one or more elements of the query are identified;
comparing the one or more elements of the query against a prior query, wherein a reply to the prior query was previously supplied by the particular business; and
providing a response to the query, wherein the response includes at least a portior of the reply to the prior query.

2. The method of claim 1, wherein the communication direction is a fax number associated with the particular business.

3. The method of claim 2, wherein the query is received as a fax.

4. The method of claim 1, the method further comprising:
receiving a request to identify a class of businesses, wherein the particular business is included in the class a businesses; and
graphically displaying two or more businesses included in the class of businesses in relation to a map.

5. The method of claim 4, wherein the request indicates a geographic center.

6. The method of claim 4, wherein the request indicates a geographic boundary.

7. The method of claim 4, wherein the particular business is a first business, wherein the communication direction is a first communication direction, wherein the class of businesses includes a second business, wherein the prior query is a first prior query, and wherein the method further comprises:
receiving the query via a second communication direction, wherein the second communication direction is associated with the second business;
comparing the one or more elements of the query against a second prior query, wherein a reply to the second prior query was previously supplied by the second business; and
providing a response originally received from the second business in relation to the query.

8. The method of claim 7, wherein at least a portion of the query is automatically populated from a database.

9. The method of claim 8, wherein the portion of the query includes information selected from a group consisting of: an address of a requester, the name of a requestor, and contact information associated with a requester.

10. A method for communicating information in relation to a telephone/fax covered business, the method comprising:
receiving an identification of two or more businesses via a portal, wherein the two or more businesses are of a particular business type;
receiving a query germane to the business type; and
faxing at least a portion of the query to each of the two or more businesses.

11. The method of claim 10, wherein the method further comprises:
providing a first fax number associated with a first business included in the two or more businesses;
providing a second fax number associated with a second business included in the two or more businesses;
receiving the query via the first fax number and the second fax number, wherein receiving the query includes directing the query to a third party support service;
parsing the query, wherein one or more elements of the query are identified;
comparing the one or more elements of the query against a first prior query, wherein a reply to the first prior query was previously supplied by the first business;
comparing the one or more elements of the query against a second prior query, wherein a reply to the second prior query was previously supplied by the second business;
providing a first response to the query, wherein the first response includes at least a portion of the reply to the first prior query; and
providing a second response to the query, wherein the second response includes at least a portion of the reply to the second prior query.

12. The method of claim 11, wherein faxing the portion of the message to each of the two or more businesses includes faxing a portion of the query that does not correspond to either the reply to the first prior query or the reply to the second prior query.

13. The method of claim 10, the method further comprising:
receiving a request to identify businesses of the business type near a particular location, wherein the two or more businesses are identified; and
graphically displaying the two or more businesses in relation to a map.

14. The method of claim 13, wherein the request indicates a location selected from a group consisting of: a geographic center and a geographic boundary.

15. The method of claim 10, wherein at least a portion of the query is automatically populated from a database.

16. The method of claim 15, wherein the portion of the query includes information selected from a group consisting of: an address of a requester, the name of a requestor, and contact information associated with a requester.

17. A system for responding to business related queries:
a computer,
a computer readable medium accessible to the computer, wherein the computer readable medium includes instructions executable by the computer to:
provide a fax number associated with a particular business;
receive a query via an Internet website;
direct the query to a third party support service;
parse the query, wherein one or more elements of the query are identified;
compare the one or more elements of the query against a prior query, wherein a reply to the prior query was previously supplied by the particular business; and
provide a response to the query, wherein the response includes at least a portion of the reply to the prior query.

18. The system of claim 17, wherein the computer readable medium further includes instructions executable by the computer to:
receive a request to identify a class of businesses, wherein the particular business is included in the class a businesses; and
graphically display two or more businesses included in the class of businesses in relation to a map.

19. The system of claim 18, wherein the request indicates a location selected from a group consisting of: a geographic center and a geographic boundary.

20. The system of claim 17, wherein the particular business is a first business, wherein the communication direction is a first communication direction, wherein the class of businesses includes a second business, wherein the prior query is a first prior query, and wherein the computer readable medium further includes instructions executable by the computer to:
receive the query via a second communication direction, wherein the second communication direction is associated with the second business;
compare the one or more elements of the query against a second prior query, wherein a reply to the second prior query was previously supplied by the second business; and
provide a response originally received from the second business in relation to the query.
